(19) United States
(12) Patent Application Publication
(10) Pub. No.: US 2018/0354003 A1
(43) Pub. Date: Dec. 13, 2018

(54) DEVICE AND METHOD FOR DEBURRING COMPONENTS ULTRASOUND

(71) Applicant: Weber Ultrasonics AG, Karlsbad-Ittersbach (DE)

(72) Inventor: Thomas Dreyer, Karlsruhe (DE)

(73) Assignee: Weber Ultrasonics AG, Karlsbad-Ittersbach (DE)

(21) Appl. No.: 15/568,625

(22) PCT Filed: Apr. 11, 2016
(86) PCT No.: PCT/EP2016/057920

§ 371 Date: Jan. 9, 2018

(30) Foreign Application Priority Data
Apr. 24, 2015 (DE) 102015106343.3

(51) Int. Cl. B08B 3/12; B06B 3/00; B06B 1/02

(52) U.S. Cl. CPC B08B 3/12; B06B 1/02; B06B 3/00

(57) ABSTRACT

A method is disclosed for deburring components or workpieces (7) with ultrasound by using at least one sonotrode (6), having the following method steps: a) supplying at least one ultrasonic transducer (4) with electrical energy by at least one ultrasound generator (2) so that the ultrasonic transducer (4) is caused to vibrate mechanically; b) transmitting the vibrations to the sonotrode (6) that is mechanically connected to the ultrasonic transducer (4); c) immersing the sonotrode (6) with at least one vibrating sonotrode surface (6′) into a fluid (M) so that cavitation is generated in the fluid (M) in an area of this sonotrode surface (6′) by the mechanical vibrations of the sonotrode (6); d) arranging a workpiece (7) to be deburred in the vicinity of this sonotrode surface (6′) by which the workpiece (7) is deburred on at least one point, side, or surface opposite the sonotrode surface (6′). Furthermore, a device is disclosed for deburring components or workpieces (7) using ultrasound.

### BACKGROUND

The invention relates to a method for deburring components or workpieces using ultrasound via at least one sonotrode, and to an apparatus for deburring components by means of ultrasound.

Customary methods for deburring components or workpieces are based firstly on the mechanical removal of an undesired burr by a corresponding chip-removing tool. Secondly, burrs are removed in an electrochemical or thermal way. The use of high pressure water jet methods is also known.

### SUMMARY

The invention is based on the object of specifying an alternative, effective and efficient method for deburring components or workpieces, and a corresponding apparatus. The terms “component” and “workpiece” are used as synonyms in the following text.

This object is achieved by way of a method and an apparatus having one or more features of the invention, and by way of the use of a sonotrode which is known from ultrasonic welding applications.

Advantageous refinements of the method and the apparatus are disclosed below and in the claims.

A method according to the invention for deburring components using ultrasound via at least one sonotrode comprises at least the following method steps:

a) supplying at least one ultrasonic transducer with electric energy by at least one ultrasonic generator, with the result that the ultrasonic transducer is excited to perform mechanical oscillations;

b) transmitting the oscillations to the sonotrode which is connected mechanically to the ultrasonic transducer;

c) dipping the sonotrode by way of at least one oscillating sonotrode face into a liquid, with the result that cavitation is generated in the liquid in the region of said sonotrode face by way of the mechanical oscillations of the sonotrode;

d) arranging a workpiece to be deburred in the vicinity of the sonotrode face, as a result of which the workpiece is deburred on at least one side or face which lies opposite said sonotrode face.

An apparatus according to the invention for deburring components using ultrasound comprises:

a) at least one ultrasonic transducer;

b) at least one ultrasonic generator which is configured for supplying the ultrasonic transducer with electric energy, in order to excite the ultrasonic transducer to perform mechanical oscillations;

c) at least one sonotrode which is connected mechanically to the ultrasonic transducer for the transmission of the oscillations;

d) a tank which can be filled or is filled with a liquid, with the result that the sonotrode dips or can be dipped by way of at least one oscillating sonotrode face into the liquid; and

d) a device for the defined arrangement of a workpiece to be deburred at a location in the vicinity of said sonotrode face.

It is fundamentally known from applications for cleaning components in an ultrasonic bath with a liquid or a liquid medium that the cavitation which occurs there in the liquid can damage the surfaces of components to be cleaned. This damage is produced by way of cavitation bubbles which collapse on the surface. These cavitation bubbles typically occur at flaws of the surface, since microscopic gas bubbles adhere there during the dipping into the liquid. This can be the case, in particular, on burrs and in bores. According to the findings of the applicant, this can be utilized to deburr metallic components by way of targeted cavitation action, since the energy which is released during the collapse of the individual small gas bubbles as it were blasts off possibly present burrs. Here, the component (workpiece) to be deburred should be subjected briefly to intensive ultrasound-induced cavitation, in order to carry out a deburring operation. Here, according to the findings of the applicant, the cavitation intensity which occurs in customary ultrasonic cleaning baths is insufficient, with the result that an increased cavitation intensity, as realized in the case of the subject matter of the invention, is necessary.

Furthermore, it is fundamentally known that very intensive cavitation can be achieved on the surface of sonotrodes which oscillate at an ultrasonic frequency and dip into a liquid medium. Sonotrodes are generally tools for ultrasonic welding which are set in oscillation by way of the introduction of high frequency mechanical oscillations (ultrasound). They establish the connection from the ultrasonic generator to the workpiece and introduce the oscillations into the latter. The heat which is generated by way of the friction which is produced leads to melting and to connecting of the workpiece. Sonotrodes are the only component of an ultrasonic welding machine to have direct contact with the welded part.

The reason for this intensive cavitation is the considerably higher amplitude of the mechanical deflection in comparison with conventional acoustic transducers for the cleaning technology in the case of sonotrodes. Amplitudes of this magnitude can be achieved and/or boosted by way of the use of correspondingly suitable acoustic transducers, boosting elements (booster, also called a transformer in the following text) and suitable geometry of the sonotrode. This is fundamentally known from applications for ultrasonic welding.

Accordingly, according to the invention, at least one sonotrode is introduced or can be introduced into a vessel (tank) which is filled with a (cleaning) liquid. Furthermore, in accordance with one development of the invention, said sonotrode is operated by an ultrasonic transducer at an ultrasonic frequency between 10 and 50 kHz, preferably from approximately 18 kHz to approximately 35 kHz, highly preferably from approximately 20 kHz to approximately 30 kHz, with the result that intensive cavitation is developed close to an oscillating face of the sonotrode (also called a sonotrode face in the present text).

A corresponding embodiment of the apparatus provides that the ultrasonic generator is configured for generating an ultrasonic frequency of the oscillations of at least approximately 10 kHz and at most approximately 50 kHz, preferably from approximately 18 kHz to approximately 35 kHz, highly preferably from approximately 20 kHz to approximately 30 kHz.

The workpiece to be deburred is then positioned manually or by way of a special apparatus (that is to say, a device for the defined arrangement of a workpiece to be deburred) at a defined spacing with regard to precisely said oscillating face, with the result that the intensive cavitation which occurs there leads to the elimination of burrs. The positioning is advantageously carried out or can be set in such a way that the minimum spacing from the oscillating face is at least 0.1 mm, but is less than or at most equal to one acoustic wavelength in the cleaning medium or in the (cleaning) liquid here.

A corresponding embodiment of the apparatus provides that a spacing of the workpiece from the sonotrode face can be set in such a way that it is at least approximately 0.1 mm and corresponds at most to approximately one acoustic wavelength of the liquid, preferably by way of a corresponding adjustability of the device.

It can be provided in one development of the method according to the invention that a mechanical transformer for increasing or reducing the mechanical amplitude is attached between the ultrasonic transducer and the sonotrode.

It can correspondingly be provided in one development of the apparatus that a mechanical transformer for increasing or reducing the mechanical amplitude is attached between the ultrasonic transducer and the sonotrode.

In one development of the invention, furthermore, a device can be provided which leads the workpieces to be deburred over the oscillating sonotrode face continuously or discontinuously, preferably approximately parallel to said sonotrode face. This can advantageously be realized by way of the provision of a drive chain or another suitable transport system. One feature here is the maintenance of a constant but adjustable spacing from the oscillating face of the sonotrode, which is preferably monitored continuously.

It can be provided in one corresponding development of the apparatus that the device is configured in the form of a transport device for the continuous or discontinuous feed of workpieces at an adjustable spacing from the oscillating face of the sonotrode. This can have a monitoring device which is configured for continuously monitoring the maintenance of a constant spacing from the sonotrode face.

It can be provided in yet another development of the method according to the invention that a lift movement is carried out substantially perpendicularly with respect to the sonotrode face by the transport device or the transport system, with the result that the positioning of the workpieces above the oscillating face is achieved.

It can be provided in one corresponding development of the apparatus that the transport device is configured for carrying out a lift movement substantially perpendicularly with respect to the sonotrode face.

A further advantageous embodiment of the apparatus comprises a receiving apparatus for the workpieces to be deburred, which receiving apparatus is guided or can be guided onto the oscillating face of the sonotrode by a positioning device. An apparatus for the maintenance of a constant spacing from the oscillating face of the sonotrode can also be provided here. This apparatus can be configured for ultrasonic distance measurement, for optical distance measurement, for inductive distance measurement or for distance measurement via the travel or lift, without the invention being restricted hereto.

It can be provided in one particularly advantageous development of the method according to the invention that more than one sonotrode is introduced into the liquid and excited to oscillate in such a way that more than one side of the workpiece is loaded or can be loaded with ultrasound at the same time.

In terms of apparatus technology, it can correspondingly be provided that more than one sonotrode is arranged and is introduced or can be introduced into the liquid and is excited or can be excited to oscillate in such a way that more than one side of the workpiece can be loaded with ultrasound at the same time.

It can be provided in yet another development of the method according to the invention that a plurality of sonotrodes with at least partially different dimensions and/or geometries of the respective sonotrode face are used.

Furthermore, an adaptation to modified workpiece dimensions can be achieved by way of a change of sonotrodes with emitting faces of different geometry. In terms of the apparatus, it can also be provided that a plurality of sonotrodes are provided which have at least partially different dimensions of their respective sonotrode face.

It can be provided in one development of the apparatus that a vibration system, comprising the ultrasonic transducer, the sonotrode and possibly the transformer, is fixed on the tank in a region of minimum mechanical deflection (vibration node), preferably in the region of that vibration node which lies closest to the sonotrode face. As a result, the dipping depth of the vibration system or of the sonotrode into the liquid can be minimized, which can have a favorable effect on the required liquid volume and the tank size.

It can be provided in another development of the apparatus that a plurality of vibration systems, in each case comprising the ultrasonic transducer, the sonotrode and possibly the transformer, are fixed on the tank in each case in a region of minimum mechanical deflection, with the result that the respective sonotrode faces are arranged at different points relative to the location, in order that more than one side of the workpiece to be deburred can be irradiated ultrasonically.

It can be provided in yet another development of the apparatus that the device for arranging the workpiece or the workpieces is configured in such a way that a location of the workpiece to be deburred is not covered and can dip freely into the liquid, in order to make possible deburring which is as efficient as possible.

### BRIEF DESCRIPTION OF THE DRAWINGS

In the following text, further properties and advantages of the invention will be described with reference to the drawing, in which:

FIG. 1 diagrammatically shows a first refinement of the apparatus according to the invention,

FIG. 2 diagrammatically shows the location-dependent waveform in the case of an ultrasonic vibration system having a sonotrode,

FIG. 3 diagrammatically shows a second refinement of the apparatus according to the invention,

FIG. 4 diagrammatically shows a third refinement of the apparatus according to the invention,

FIG. 5 shows a possible arrangement of a plurality of sonotrodes in accordance with a further refinement of the apparatus according to the invention, and

FIG. 6 shows sonotrodes of different shape for use in an apparatus according to the invention.

### DETAILED DESCRIPTION OF THE PREFERRED EMBODIMENTS

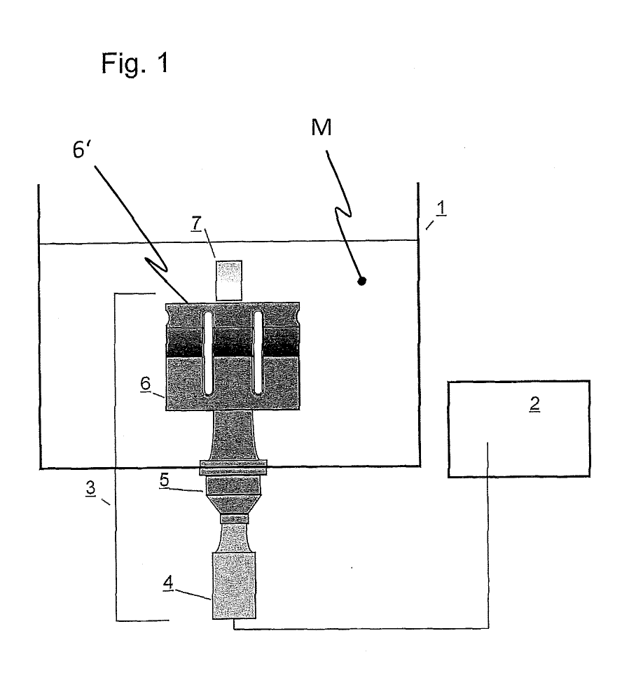

FIG. 1 diagrammatically shows one exemplary embodiment of the apparatus according to the invention. An ultrasonic vibration system 3 is mounted in a tank 1 which is filled with liquid cleaning medium M. The ultrasonic vibration system 3 comprises an ultrasonic transducer (or converter) 4 for converting electric oscillations into mechanical vibrations, a booster (transformer) 5 for increasing mechanical deflection, and a sonotrode 6. The designation 6′ denotes a face of the sonotrode which radiates oscillations (as an alternative, also called an “oscillating face of the sonotrode” or the “sonotrode face”). Here, the individual components 4-6 of the vibration system 3 are connected to one another by way of screw connections (not shown) and can therefore be replaced. The converter 4 is operatively connected to an ultrasonic generator 2 and is supplied by the latter with electric energy. Here, the ultrasonic generator 2 has a regulator which regulates the mechanical amplitude of the converter 4 and makes it possible to set said amplitude in a range from, for example, 10 to 100% in relation to a maximum mechanical amplitude. Ultrasonic generators of this type are known to a person skilled in the art and are used, for example, in devices for ultrasonic welding.

According to FIG. 1, a workpiece 7 to be deburred is positioned at a spacing of at least 0.1 mm and at most one acoustic wavelength of the cleaning liquid M in the case of the radiating face 6′ of the sonotrode, and is ultrasonically irradiated for a certain time which depends on the type of workpiece 7 and the existing quantity of burrs, etc., and can be determined, for example, from corresponding preliminary tests.

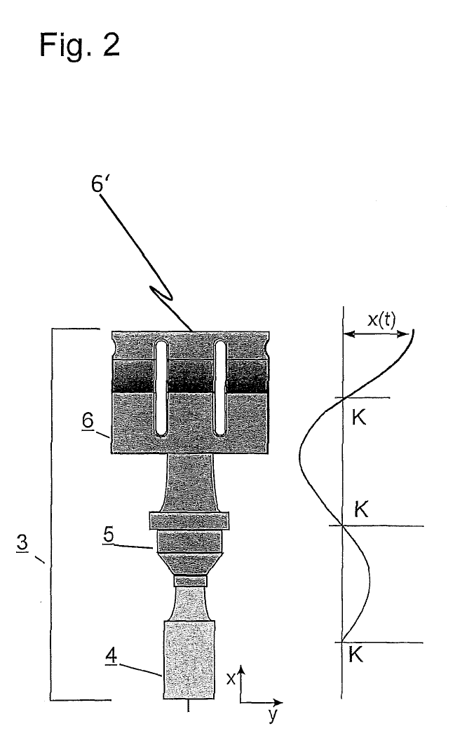

FIG. 2 once again shows the construction of the exemplary vibration system 3 from FIG. 1 for illustrative purposes. The principal location-dependent waveform of the axial mechanical deflection x(t) of the respective components 4-6 of the vibration system 3 is likewise shown, from which waveform the described boosting arises: the amplitude increases from the converter 4 to the sonotrode 6. Furthermore, regions exist, in which the deflection disappears, what are known as node points K, x(K)=0. It is then particularly advantageous to fasten said vibration system 3 to further components of the apparatus precisely at said node points K. A flange (not shown) for fixing the vibration system 3 on the tank 1 from FIG. 1 will advantageously be fastened at one of said node points K (cf. FIG. 1).

In a deviation from the illustration in FIG. 1, it can also be provided to fasten the vibration system 3 in the region of the uppermost (front-most) node point K in accordance with FIG. 2. As a result, the dipping depth into the medium M can be minimized, which can have a favorable effect on the required liquid volume.

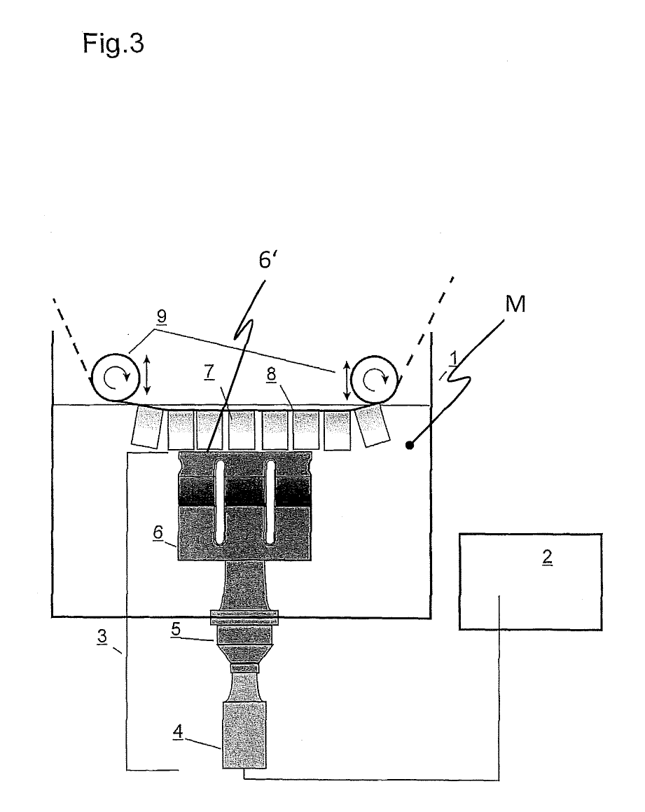

A further advantageous refinement of the apparatus according to the invention is shown in FIG. 3. Here, the tank 1 including the vibration system 3 is upgraded by way of an apparatus 8 (transport apparatus) for the continuous transport of workpieces 7. The transport apparatus 8 can comprise, for example, a link chain, into which the individual workpieces 7 are hooked or can be hooked. This link chain can be moved continuously or discontinuously over the oscillating face 6′ or parallel to the latter by way of a drive apparatus 9, for example driven rollers or gearwheels. Furthermore, the transport apparatus 8 comprises a device, by way of which the spacing of the workpieces 7 from the sonotrode face 6′ can be set, as symbolized in FIG. 3 by way of vertical double arrows. The apparatus can be configured for continuous monitoring and setting of said spacing.

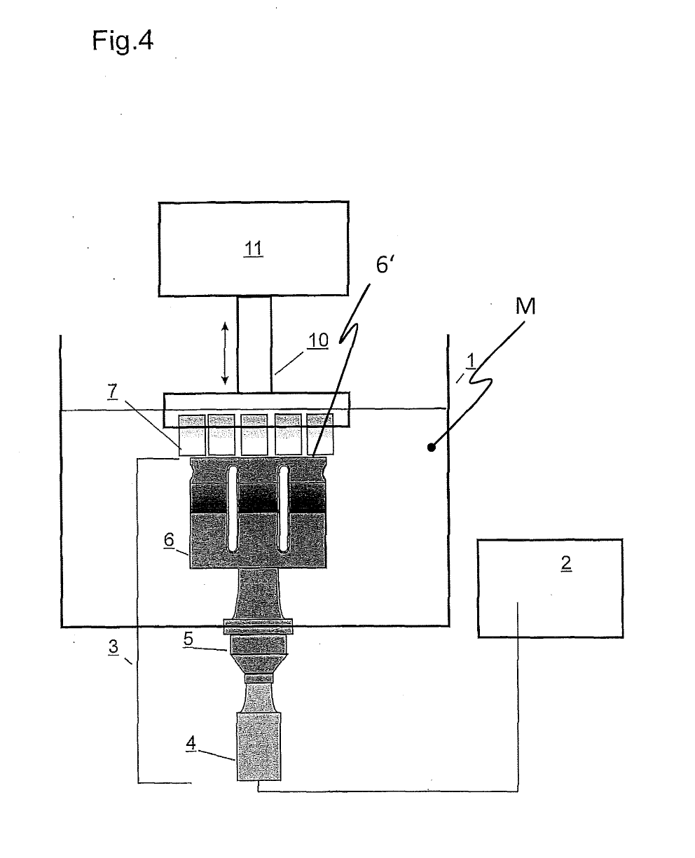

A further advantageous refinement of the apparatus according to the invention is shown in FIG. 4. Here, a further device 10 for receiving a plurality of workpieces 7 is situated above the tank 1 with a vibration system 3 according to the invention. This device 10 can be, for example, a basket, a product carrier or another carrier which is adapted to the geometry of the workpieces. The carrier or the device 10 is advantageously designed in such a way that the face to be deburred of the workpieces 7 is not covered and can dip freely into the cleaning medium M. Furthermore, the product carrier or the device 10 is connected to a lift and transport mechanism 11, by way of which the product carrier or the device 10 can be dipped into the cleaning medium M, as shown. Furthermore, the lift mechanism 11 preferably has the property that the spacing of the workpieces 7 from the sonotrode face 6′ can be set selectively, as symbolized in FIG. 4 by way of a vertical double arrow.

Without further description, combinations or juxtapositions of the embodiments which are disclosed in FIG. 1, FIG. 3 and FIG. 4 to form larger devices are also possible for a person skilled in the art and are therefore likewise a constituent part of the present invention.

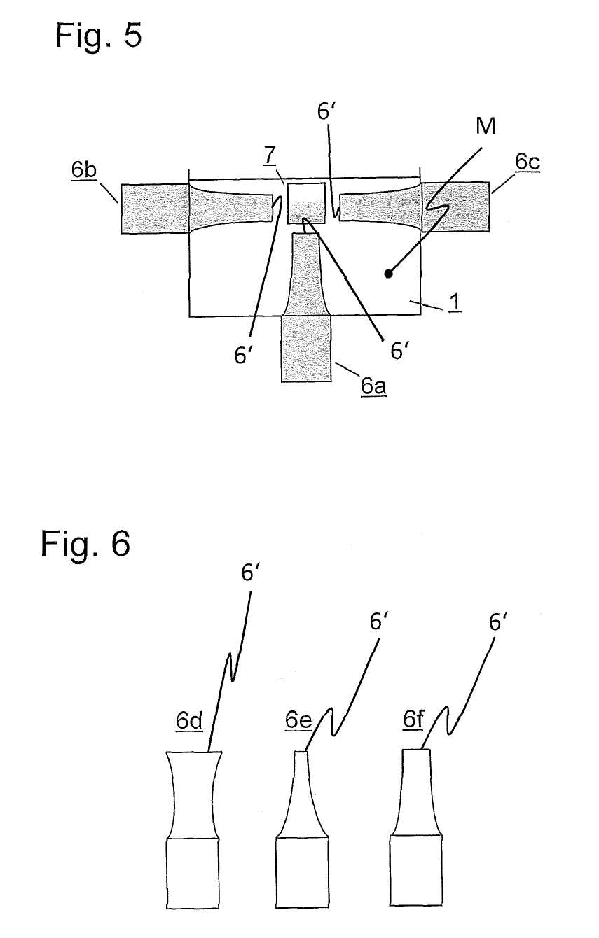

Depending on the geometry of the components or workpieces 7, simultaneous deburring of a plurality of component faces or faces of the workpieces 7 can be advantageous for time and/or cost reasons. To this end, for example, the arrangement (shown in FIG. 5) of a plurality of sonotrodes 6a-6c is highly advantageous. For example, three sonotrodes 6a, 6b and 6c can be mounted on a tank 1 in such a way that three sides of a workpiece 7 can be deburred at the same time according to the invention. The sonotrodes 6a-6c which are used do not have to be of identical configuration.

A further advantageous refinement of the apparatus according to the invention is shown in FIG. 6, in which various ultrasonic sonotrodes 6d to 6f with different dimensions and geometries of the radiating faces are shown. In the context of the present invention, said sonotrodes 6d-6f can preferably be exchanged in the case of an apparatus according to the invention, with the result that the apparatus can be configured, for example, such that it can be adapted to different dimensions or geometries of the workpieces 7 to be deburred and/or to different burr types, etc.

1. A method for deburring workpieces (7) using ultrasound via at least one sonotrode (6; 6a, 6b, 6c), comprising the following method steps:
a) supplying at least one ultrasonic transducer (4) with electric energy by at least one ultrasonic generator (2), thereby exciting the ultrasonic transducer (4) to perform mechanical oscillations;
b) transmitting the oscillations to the at least one sonotrode (6) which is connected mechanically to the ultrasonic transducer (4);
c) dipping at least one oscillating sonotrode face (6′) of the at least one sonotrode (6) into a liquid (M), thereby generating cavitation in the liquid (M) in a region of said sonotrode face (6′) by way of mechanical oscillations of the sonotrode (6);
d) arranging a workpiece (7) to be deburred in a vicinity of the sonotrode face (6′), and deburring the workpiece (7) on at least one side or face which lies opposite said sonotrode face (6′).

2. The method as claimed in claim 1, wherein a generated ultrasonic frequency of the oscillations is at least approximately 10 kHz and at most approximately 50 kHz.

3. The method as claimed in claim 1, wherein a spacing of the workpiece (7) from the sonotrode face (6′) is at least approximately 0.1 mm and at most to approximately one acoustic wavelength of the oscillations in the liquid (M).

4. The method as claimed in claim 1, wherein a mechanical amplitude of the oscillations is attached between the ultrasonic transducer (4) and the sonotrode (6).

5. The method as claimed in claim 1, further comprising providing a continuous or discontinuous feed of workpieces (7) by a transport device (8; 11) at an adjustable spacing from the sonotrode face (6′).

6. The method as claimed in claim 5, further comprising carrying out a lift movement substantially perpendicularly with respect to the sonotrode face (6′) by the transport device (11), thereby achieving a positioning of the workpieces (7) above the sonotrode face (6′).

7. The method as claimed in claim 1, further comprising continuously monitoring and maintaining a constant spacing of the workpiece from the sonotrode face (6′).

8. The method as claimed in claim 1, wherein there are a plurality of the sonotrodes (6a, 6b, 6c) that are introduced into the liquid (M) and excited to oscillate, and the method further comprises loading more than one side of the workpiece (7) with ultrasound at the same time.

9. The method as claimed in claim 1, wherein there are a plurality of the sonotrodes (6d, 6e, 6f), each having at least partially different dimensions of the respective sonotrode face (6′).

10. An apparatus for deburring workpieces (7) using ultrasound, comprising:
a) at least one ultrasonic transducer (4);
b) at least one ultrasonic generator (2) which is configured for supplying the ultrasonic transducer (4) with electric energy, in order to excite the ultrasonic transducer (4) to perform mechanical oscillations;
c) at least one sonotrode (6) which is connected mechanically to the ultrasonic transducer (4) for transmission of the oscillations;
d) a tank (1) which is fillable or is filled with a liquid (M), with the sonotrode (6) having at least one oscillating sonotrode face (6′) that is dippable or dipped into the liquid (M); and
d) a device (8, 9; 10, 11) that arranges a workpiece (7) to be deburred at a location in a vicinity of said sonotrode face (6′).

11. The apparatus as claimed in claim 10, wherein the ultrasonic generator (2) is configured for generating an ultrasonic frequency of the oscillations of at least approximately 10 kHz and at most approximately 50 kHz.

12. The apparatus as claimed in claim 10, wherein a spacing of the workpiece (7) from the sonotrode face (6′) set to be at least approximately 0.1 mm and corresponds at most approximately to one acoustic wavelength of the oscillations in the liquid (M).

13. The apparatus as claimed in claim 10, further comprising a mechanical transformer (5) for increasing or reducing a mechanical amplitude of the oscillations is attached between the ultrasonic transducer (4) and the sonotrode (6).

14. The apparatus as claimed in claim 10, further comprising a transport device (8; 11) for continuous or discontinuous feed of workpieces (7) at an adjustable spacing from the sonotrode face (6′).

15. The apparatus as claimed in claim 14, wherein the transport device (11) is configured for carrying out a lift movement substantially perpendicularly with respect to the sonotrode face (6′), or the transport device (8) is configured for carrying out a movement substantially parallel to the sonotrode face (6′).

16. The apparatus as claimed in claim 10, further comprising a monitoring device which is configured for continuously monitoring a maintenance of a constant spacing of the workpiece (7) from the sonotrode face (6′).

17. The apparatus as claimed in claim 10, wherein there are more than one of the sonotrodes (6) which are arranged and introduced into the liquid (M) and are excited or excitable to oscillate in such a way that more than one side of the workpiece (7) can be loaded with ultrasound at the same time.

18. The apparatus as claimed in claim 10, wherein a plurality of the sonotrodes (6a, 6b, 6c; 6d, 6e, 6f) are provided which have at least partially different dimensions of the respective sonotrode faces (6′).

19. The apparatus as claimed in claim 10, wherein a vibration system (3), comprising the ultrasonic transducer (4) and the sonotrode (6), is fixed on the tank (1) in a region (K) of minimum mechanical deflection (x(t)).

20. The apparatus as claimed claim 10, wherein a plurality of vibration systems (3), in each case comprising the ultrasonic transducer (4) and the sonotrode (6), are fixed on the tank (1) in each case in a region (K) of minimum mechanical deflection (x(t)), with the respective sonotrode faces (6′) arranged at different points relative to the location.

21. The apparatus as claimed in claim 10, wherein the device (8, 9; 10, 11) for arranging the workpiece (7) is configured in such a way that the location of the workpiece (7) to be deburred is not covered and can dip freely into the liquid (M).

22. A method of deburring workpieces, comprising generating oscillations in a liquid with a sonotrode (6; 6a, 6b, 6c; 6d, 6e, 6f) that are directed toward a workpiece, and deburring the workpiece with the oscillations of the liquid impacting the workpiece.
